(19) United States
(12) Patent Application Publication
(10) Pub. No.: US 2004/0200291 A1
(43) Pub. Date: Oct. 14, 2004

(54) Multilayer ceramic pressure sensor

(76) Inventors: Xunhu Dai, Gilbert, AZ (US); Daniel Zindel, Mesa, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/412,189

(22) Filed: Apr. 11, 2003

(51) Int. Cl. G01L 1/22

(52) U.S. Cl. 73/766

(57) ABSTRACT

An exemplary system and method for integrated pressure sensing is disclosed as including inter alia: a sensing cavity having a surface capable of mechanical deformation; a plurality of piezoresistors; a plurality of electrical contact pads; a plurality of conductive pathways connecting the piezoresistors and the contact pads; and a monolithic device package. Disclosed features and specifications may be variously controlled, adapted or otherwise optionally modified to improve sensing in any microfluidic application. Exemplary embodiments of the present invention representatively provide for sensing fluid pressures in a microfluidic channel or reservoir. Representatively disclosed embodiments may be readily integrated with existing portable ceramic technologies for the improvement of device package form factors, weights and other manufacturing and/or device performance metrics.

### FIELD OF INVENTION

The present invention relates to pressure sensors, and more particularly, in one representative and exemplary embodiment, to multilayer ceramic pressure sensors having piezoresistive features for improved performance, efficiency and fabrication cost savings in low temperature cofired ceramic (LTCC) applications.

### BACKGROUND

Development of microfluidic technology has generally been driven by parallel ontological advancements in the commercial electronics industry with the ever-increasing demand for sophisticated devices having reduced part counts, weights, form factors and power consumption while improving or otherwise maintaining overall device performance. In particular, advancement of microfluidic technology has met with some success in the areas of packaging and the development of novel architectures directed to achieving many of these aims at relatively low fabrication cost.

The development of microfluidic systems, based on for example, multilayer laminate substrates with highly integrated functionality, have been of particular interest. Monolithic substrates formed from laminated ceramic have been generally shown to provide structures that are relatively inert or otherwise stable to most chemical reactions as well as tolerant to high temperatures. Additionally, monolithic substrates typically provide for miniaturization of device components, thereby improving circuit and/or fluidic channel integration density. Potential applications for integrated microfluidic devices include, for example, fluidic management of a variety of microsystems for life science and portable fuel cell applications. One representative application includes the use of ceramic materials to form micro-channels and/or cavities within a laminate structure to define, for example, a high aspect ratio micropump.

Conventional pumps and pumping designs have been used in several applications; however, many of these are generally too cumbersome and complex for application with microfluidic systems. For example, existing designs typically employ numerous discrete components externally assembled or otherwise connected together with plumbing and/or component hardware to produce ad hoc pumping systems. Consequently, conventional designs have generally not been regarded as suitable for integration with sensors or other portable ceramic technologies or in various applications requiring, for example, reduced form factor, weight or other desired performance and/or fabrication process metrics. Moreover, previous attempts with integrating sensors in laminated substrates have met with considerable difficulties in producing reliable fluidic connections and/or hermetic seals capable of withstanding manufacturing processes and/or operational stress while maintaining or otherwise reducing production costs. Accordingly, despite the efforts of prior art pump designs to miniaturize and more densely integrate components for use in microfluidic systems, there remains a need for high aspect ratio microfluidic systems having integrated pressure systems suitably adapted for incorporation with, for example, a monolithic device package.

### SUMMARY OF THE INVENTION

In various representative aspects, the present invention provides a system and method for integrated piezoresistive pressure sensing in microfluidic systems. A representative design is disclosed as comprising a sensing cavity with a surface capable of mechanical deflection; a plurality of piezoresistors; a plurality of electrical contact pads; a plurality of conductive traces connecting the piezoresistors and the contact pads; and a monolithic device package. A piezoresistive pressure sensing element in accordance with one embodiment of the present invention, may be formed utilizing multilayer ceramic technology in which piezoresistors are integrated into a laminated ceramic structure; however, the disclosed system and method may be readily and more generally adapted for use in any microfluidic system. For example, the present invention may embody a device and/or method for providing integrated sensing systems for use in fuel cell fuel delivery and/or chromatographic partitioning applications.

One representative advantage of the present invention would allow for improved process control and manufacturing of integrated microfluidic systems at substantially lower cost. Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being had to the accompanying drawings forming a part hereof, wherein like numerals refer to like parts throughout. Other elements, operational features, applications and/or advantages will become apparent to skilled artisans in light of certain exemplary embodiments recited in the detailed description, wherein:

FIG. 1 representatively depicts a top plan view of a pressure sensor device package in accordance with an exemplary embodiment of the present invention;

FIG. 2 representatively illustrates a cross-section, side view of the sensor device package generally depicted in FIG. 1 along the ‘2-2’ axis;

FIG. 3 representatively illustrates a cross-section, side view of the sensor device package generally depicted in FIG. 1 along the ‘3-3’ axis;

FIG. 4 representatively illustrates a cross-section, plan view of the sensor device package generally depicted in FIG. 1; and

FIG. 5 representatively illustrates a bottom plan view of the sensor device package generally depicted in FIG. 1.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention.

### DETAILED DESCRIPTION OF EXEMPLARY EMBODIMENTS

The following descriptions are of exemplary embodiments of the invention and the inventors' conceptions of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system and/or method for fluid containment and/or transport. As used herein, the terms “fluid”, “fluidic” and/or any contextual, variational or combinative referent thereof, are generally intended to include anything that may be regarded as at least being susceptible to characterization as generally referring to a gas, a liquid, a plasma and/or any matter, substance or combination of compounds substantially not in a solid or otherwise effectively immobile condensed phase. As used herein, the terms “inlet” and “outlet” are generally not used interchangeably. For example, “inlet” may generally be understood to comprise any cross-sectional area or component feature of a device, the flux through which tends to translate fluid from a volume element substantially external to the device to a volume element substantially internal to the device; whereas “outlet” may be generally understood as referring to any cross-sectional area or component feature of a device, the flux through which tends to translate fluid from a volume element substantially internal to the device to a volume element substantially external to the device. On the other hand, as used herein, the terms “liquid” and “gas” may generally be used interchangeably and may also be understood to comprise, in generic application, any fluid and/or any translationally mobile phase of matter. As used herein, the term “purged”, as well as any contextual or combinative referent or variant thereof, is generally intended to include any method, technique or process for moving a volume element of fluid through the outlet of a device so as to dispose or otherwise positionally locate the “purged” volume element external to the device. Additionally, as used herein, the terms “sensor” and “sensing”, as well as any contextual or combinative referents or variants thereof, are generally intended to include any method, technique, process, apparatus, device and/or system suitably adapted to control, affect or otherwise monitor fluid flow scalar quantities (e.g., volume, pressure, density, viscosity, etc.) and/or fluid flow vector quantities (i.e., direction, velocity, acceleration, jerk, etc.). Additionally, as used herein, the terms “pump” and “pumping”, or any contextual or combinative referents or variants thereof, are generally intended to include any method, technique, process, apparatus, device and/or system suitably adapted to flow or otherwise translate a fluid volume element from a first location to a second location.

A detailed description of an exemplary application, namely a system and method for making a piezoresistive sensing element in a laminar device package is provided as a specific enabling disclosure that may be readily generalized by skilled artisans to any application of the disclosed system and method for microfluidic transport, containment and/or sensing in accordance with various embodiments of the present invention. Moreover, skilled artisans will appreciate that the principles of the present invention may be employed to ascertain and/or realize any number of other benefits associated with fluid transport such as, but not limited to: improvement of pumping efficiency; reduction of device weight; reduction of device form factor; improved sample loading in microfluidic assays; improvement in sample throughput; sample multiplexing and/or parallel sample processing; integration with micro-array techniques and/or systems; microfluidic sample transport; pumping of fuel and/or fuel components in a fuel cell system and/or device; and any other applications now known or hereafter developed or otherwise described in the art.

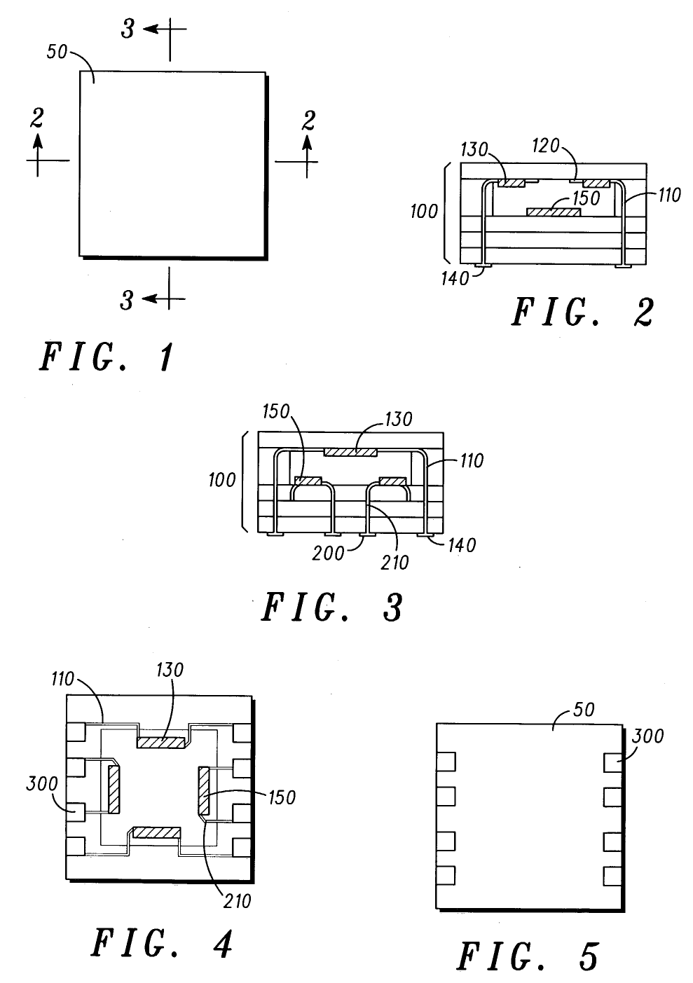

In one representative application, in accordance with an exemplary embodiment of the present invention, a pressure sensing component, as generally depicted, for example, in FIGS. 1-5, is disclosed. The device package 50 generally includes: a plurality of piezoresistors 130, 150 disposed within a sensing cavity; a plurality of contact pads 140, 200, 300; a plurality of conductive pathways 110, 210 communicably connecting piezoresistors 130, 150 with contact pads 140, 200, 300. The sensing cavity is substantially internally disposed within the device package. Another exemplary embodiment of the present invention describes a novel fabrication method for manufacturing piezoresistive pressure sensor devices in multilayer ceramic (MLC) structures with low temperature cofired ceramic (LTCC) technologies.

In one exemplary embodiment, in accordance with various representative aspects of the present invention, piezoresistors 130, 150 may comprise at least one sensing piezoresistor 130 disposed near a sensing area of the sensing cavity. A sensing area may include any surface or any portion of a surface capable of at least partial mechanical deflection or deformation so as to mechanically actuate the resistance value of a sensing piezoresistor 130 in correspondence to the mechanical deflection or deformation of the sensing area. The device may also include reference piezoresistors 150 disposed effectively displaced, set away or otherwise positionally removed from the sensing area of the sensing cavity such that mechanical deformation of the sensing area does not effectively actuate the resistance of the reference piezoresistor 150.

For example, a cavity with single layer of tape ceramic provided as sensing membrane may be formed in a multilayer ceramic structure using inter alia DuPont 951 GreenTape™ (available from DuPont Microcircuit Materials, E. I. Du Pont de Nemours and Company, 14 T. W. Alexander Drive, Research Triangle Park, N.C., USA), as representatively depicted in FIG. 2. Cofireable piezoresistive pastes such as, for example, 3414 series (available from Electro-Science Lab, 416 East Church Road, King of Prussia, Pa. 19406-2625, USA) may be used to form sensing resistors on the sensing membrane and reference resistors away from the sensing cavity. Discrete piezoresistive components may also be alternatively, conjunctively and/or sequentially employed.

Pressure or load sensing may be achieved through a resistor layout employing, for example, a Wheatstone bridge configuration. Operational tests have demonstrated pressure sensitivities on the order of about 1.3 mV/kPa for 1.6 mil thick ceramic membrane over a 200 mil square cavity.

Sensing resistors 130 may be disposed on a sensing membrane surface while reference resistors 150 may be positioned on a generally mechanically inactive surface of the sensing cavity, as generally depicted, for example, in FIGS. 2 and 3. Conductor pathways 110, 210 may be externally accessed, for example, by typical multi-layer ceramic interconnection to surface I/Os.

In one exemplary embodiment, the utilization of cofireable piezoresistive paste and LTCC tape dielectric to form piezoresistors inside MLC cavity would substantially reduce packaging cost. Moreover, the sensing unit could be easily integrated with other multi-layer ceramic functionalities to form multi-layer 100 based microsystems. Additionally, reference resistors 150 may be cofired onto the bottom of the sensing cavity, thus permitting a similar interface for all resistors inter alia to minimize the effect of resistance from piezoresistor/LTCC interaction.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1-20. (cancelled)

21. A pressure sensing device, comprising:
a first ceramic layer;
a second ceramic layer having a first portion of a first side adjacent to the first ceramic layer and a second portion of the first side forming a cavity with the first ceramic layer, wherein the second ceramic layer is deformable due to a change in pressure on a second side, the first ceramic layer being substantially not deformed by the change in pressure;
a first piezoresistor positioned on the first ceramic layer and within the cavity;
a second piezoresistor positioned on a second side of the second ceramic layer and within the cavity; and
a first contact pad coupled to the first piezoresistor for receiving a first signal therefrom; and
a second contact pad coupled to the second piezoresistor for receiving a second signal therefrom, wherein the first and second signals are compared to indicate the change in pressure.

22. The pressure sensing device according to claim 21, wherein the first and second ceramic layers comprise low temperature cofired ceramics.

23. A method for making a pressure sensing device, comprising:
providing a first ceramic layer;
providing a second ceramic layer having a first portion of a first side adjacent to the first ceramic layer and a second portion of the first side forming a cavity with the first ceramic layer, wherein the second ceramic layer is deformable due to a change in pressure on a second side, the first ceramic layer being substantially not deformed by the change in pressure;
providing a first piezoresistor positioned on the first ceramic layer and within the cavity;
providing a second piezoresistor positioned on the first side of the second ceramic layer and within the cavity; and
providing a first contact pad coupled to the first piezoresistor for receiving a first signal therefrom; and
providing a second contact pad coupled to the second piezoresistor for receiving a second signal therefrom, wherein the first and second signals are compared to indicate the change in pressure.

24. The method according to claim 23 wherein providing the first and second ceramic layers comprise providing first and second low temperature cofired ceramic layers.
